(19) United States
(12) Patent Application Publication
(10) Pub. No.: US 2015/0305392 A1
(43) Pub. Date: Oct. 29, 2015

(54) AERATED NUT BUTTER

(71) Applicant: DUPONT NUTRITION BIOSCIENCES APS, Copenhagen K (DK)

(72) Inventor: Jesse Alexander, Overland Park, KS (US)

(21) Appl. No.: 14/648,440

(22) PCT Filed: Dec. 2, 2013
(86) PCT No.: PCT/IB2013/060572

§ 371 Date: May 29, 2015

Related U.S. Application Data
(60) Provisional application No. 61/732,623, filed on Dec. 3, 2012.

(30) Foreign Application Priority Data
Jan. 8, 2013 (GB) 1300288.6

(51) Int. Cl. A23L 1/38; A23L 1/00

(52) U.S. Cl. CPC A23L 1/38; A23L 1/0097; A23V 2002/00

(57) ABSTRACT

An aerated nut butter comprising lactic acid esters of mono-and diglycerides.

The present invention relates to aerated nut butter. More particularly, the present invention relates to aerated peanut butter.

### BACKGROUND TO THE INVENTION

Nut butters, such as peanut butter, are popular food products throughout the world. They are typically used as spreads on bread, toast and the like, but may also be consumed alone or in combination with other foodstuffs.

Peanut butter is typically comprised primarily of a mixture of solid nut particles and liquid oil. Other ingredients may optionally be present such as salt and other flavourings. Due to its typically high solid content, natural peanut butter is often highly viscous and takes on a paste-like form. This paste-like form facilitates the spreading of the butter onto various foodstuffs.

Over the years, natural peanut butter has been modified to include a significant proportion of air. These aerated peanut butters have a number of desirable characteristics such as a lighter texture which enables improved dipping of the peanut butter. Aerated peanut butters may also contain reduced amounts of calories and fat per serving compared to natural peanut butters and so there is a considerable interest in such aerated butters.

However, the incorporation of air into nut butters, such as peanut butter, may also lead to a number of problems with regard to the look, texture and mouthfeel of the butter. For example, aerated peanut butters often suffer from problems with the stability of the incorporated air in the sense that the air may not be sufficiently held by the peanut butter and thus collapse of the aerated structure can occur.

Further, even distribution of the incorporated air may be difficult and problems in this regard can lead to products which contain large air pockets which damage the appearance of the product to the consumer and can also lead to problems during packaging.

A number of documents describe how people have tried to improve the stability of aerated peanut butters.

U.S. Pat. No. 5,202,147 identifies potential problems associated with aerated peanut butter. In particular, issues with lightening of the peanut butter, along with flavor dilution as a result of aeration are known to occur. Further, U.S. Pat. No. 5,202,147 mentions that typical formulations and methods for producing whipped (aerated) peanut butter has relied on the use of gelatin or other thickening agents to help stabilize the products. Additional use of hydrogenated and partially hydrogenated high melting vegetable oils as stabilizers to reduce oil separation is also mentioned. In order to provide improved aerated peanut butters, U.S. Pat. No. 5,202,147 suggests the use of a specific method utilizing high pressures and rapid deep chilling in order to reduce the particle size of the incorporated gas.

WO 92/20243 is also concerned with providing improvements in respect of aerated nut butters, in particular peanut butters. In particular, WO 92/20243 suggests reducing the fat content of the peanut butter in order to improve stability. It is also suggested that a significant improvement in aeration stability will be achieved by adding increased levels of a fully hydrogenated fraction of palm oil which is high in 2-stearoyldipalmitin (PSP) triglycerides and tripalmitin (PPP) triglycerides. WO 92/20243 also places emphasis on the use of the correct type of hardstock, and also the introduction of the air (gas) under specific pressure.

Further problems with the aerated peanut butters of the prior art is that the air cells vary in size and distribution allowing for limited air incorporation, producing a less stable product and a visually unappealing product.

The present invention provides further aerated nut butter compositions with improved stability, texture and appearance.

### SUMMARY OF THE INVENTION

In one aspect of the present invention there is provided an aerated nut butter comprising lactic acid esters of mono-and diglycerides.

In another aspect of the present invention there is provided the use of lactic acid esters of mono-and diglycerides for improving the air stability of an aerated nut butter.

In another aspect of the present invention there is provided a process for preparing an aerated nut butter comprising the steps of:

i) preparing a nut butter comprising nut derived solids, nut derived oil, and lactic acid esters of mono-and diglycerides;

ii) incorporating air in the nut butter to achieve an air incorporation of from 5 to 40% by volume of the aerated nut butter.

These and other aspects of the present invention will be apparent from the below detailed description. In this regard, it is pointed out that the teachings contained in each section are not limited to that section and may be combined with the teachings of other sections.

### BRIEF DESCRIPTION OF FIGURES

FIG. 1—G′ and G″ measurements for a peanut butter sample comprising 2.0 wt. % Grindsted® PS 105 K-A.

FIG. 2—G′ and G″ measurements for a peanut butter sample comprising 0.5 wt. % LACTEM and 1.5 wt. % Grindsted® PS 105 K-A.

FIG. 3—G′ and G″ measurements for a peanut butter sample comprising 0.5 wt. % LACTEM and 1.5 wt. % Dimodan HP.

FIG. 4—G′ and G″ measurements for a peanut butter sample comprising 0.5 wt. % LACTEM and 1.5 wt. % PS 208/B K-A.

FIG. 5—G′ and G″ measurements for a peanut butter sample comprising 0.25 wt. % LACTEM and 1.5 wt. % PS 208/B K-A.

FIG. 6—An image of peanut butter sample 1 containing 1.5 wt. % PS 208.

FIG. 7—An image of peanut butter sample 2 containing 2 wt. % PS 105.

FIG. 8—An image of peanut butter sample 3 containing 2 wt. % Dimodan HP.

FIG. 9—An image of peanut butter sample 4 containing 1.5 wt. % PS 105 and 0.5 wt. % PGE.

FIG. 10—An image of peanut butter sample 6 containing 1.5 wt. % PS 105 and 0.5 wt. % PGMS.

FIG. 11—An image of peanut butter sample 5 containing 1.5 wt. % PS 105 and 0.5 wt. % LACTEM.

FIG. 12—An image of peanut butter sample 7 containing 1.5 wt. % PS 208 and 0.5 wt. % LACTEM.

### DETAILED DESCRIPTION OF THE INVENTION

In one aspect of the present invention there is provided an aerated nut butter comprising lactic acid esters of mono-and diglycerides.

### Aerated

In the context of the present invention, the term “aerated” refers to a nut butter that has at least 5% of air incorporated into the nut butter structure by volume of the final product. The aeration may be performed by any suitable means including whipping or injection.

In this regard, “air” is understood to mean any gas that is deemed suitable for incorporation into foodstuffs, e.g. nitrogen.

In other words the present invention may be considered to relate to a nut butter, as defined further herein, comprising at least 5% air incorporated into the nut butter structure by volume.

The production and measurement of “aereated” products can be achieved according to routine laboratory practices. For example, a Mondomixer (such as those from Hass-Mondomix, NL) can be used to prepare aerated products. Where an aerated product is compared to a non-aerated product and the volumes are equal, the % air incorporation of the final aerated product can also be referred to as % air incorporation relative to the unareated product.

### Nut Butter

In the context of the present invention, the term “nut butter” is understood to be a foodstuff which is a dispersion of nut derived solids in oil. The nut derived solids need not be of a defined size as they may be varied depending on the final product desired, e.g. the solids may be larger if a “crunchy” product is desired and smaller if a “smoother” product is desired. It is also to be understood that the oil is typically nut oil, although the nut butter may contain small amounts of oil (e.g. less than 10%) that are not derived from nuts.

The reference to “butter” is not limited in the sense that only products containing 100% natural ingredients are included, but extends to other products, whether 100% natural or not, that have the same characteristics of butter, i.e. are spreadable, but may be called something else.

The reference to “nut” is not limited to nuts in the botanical sense, but extends to other seeds that are considered to be nuts in the culinary sense, e.g. almond, soy and sunflower.

Therefore, in one aspect of the present invention there is provided an aerated nut butter comprising nut derived solids dispersed in oil, at least 5% by volume of the final product incorporated air and lactic acid esters of mono-and diglycerides.

In one embodiment, the amount of air incorporated into the aerated nut butter is from 5% to 50% by volume of the final product. In one embodiment, the amount of air incorporated into the aerated nut butter is from 10% to 40% by volume of the final product. In one embodiment, the amount of air incorporated into the aerated nut butter is from 15% to 40% by volume of the final product. In one embodiment, the amount of air incorporated into the aerated nut butter is from 5% to 35% by volume of the final product. In one embodiment, the amount of air incorporated into the aerated nut butter is from 5% to 30% by volume of the final product. In one embodiment, the amount of air incorporated into the aerated nut butter is from 5% to 25% by volume of the final product. In one embodiment, the amount of air incorporated into the aerated nut butter is from 10% to 25% by volume of the final product. In one embodiment, the amount of air incorporated into the aerated nut butter is from 15% to 20% by volume of the final product. In one embodiment, the amount of air incorporated into the aerated nut butter is from 20% to 50% by volume of the final product. In one embodiment, the amount of air incorporated into the aerated nut butter is from 20% to 45% by volume of the final product. In one embodiment, the amount of air incorporated into the aerated nut butter is from 25% to 45% by volume of the final product. In one embodiment, the amount of air incorporated into the aerated nut butter is from 15% to 18% by volume of the final product.

It will also be understood that the amount of air incorporated into the product can be determined based on the volume of the initial “un-aerated” nut butter. In this regard, the amount of air incorporated into the aerated nut butter is at least 5% by volume of the un-aerated product. In this regard, the amount of air incorporated into the aerated nut butter is from 5% to 50% by volume of the un-aerated product. In one embodiment, the amount of air incorporated into the aerated nut butter is from 10% to 40% by volume of the un-aerated product. In one embodiment, the amount of air incorporated into the aerated nut butter is from 15% to 40% by volume of the un-aerated product. In one embodiment, the amount of air incorporated into the aerated nut butter is from 5% to 35% by volume of the un-aerated product. In one embodiment, the amount of air incorporated into the aerated nut butter is from 5% to 30% by volume of the un-aerated product. In one embodiment, the amount of air incorporated into the aerated nut butter is from 5% to 25% by volume of the un-aerated product. In one embodiment, the amount of air incorporated into the aerated nut butter is from 10% to 25% by volume of the un-aerated product. In one embodiment, the amount of air incorporated into the aerated nut butter is from 15% to 20% by volume of the un-aerated product. In one embodiment, the amount of air incorporated into the aerated nut butter is from 20% to 50% by volume of the un-aerated product. In one embodiment, the amount of air incorporated into the aerated nut butter is from 20% to 45% by volume of the un-aerated product. In one embodiment, the amount of air incorporated into the aerated nut butter is from 25% to 45% by volume of the un-aerated product. In one embodiment, the amount of air incorporated into the aerated nut butter is from 15% to 18% by volume of the un-aerated product.

As mentioned above, the term “nut butter” is understood to be a foodstuff which is a dispersion of nut derived solids in oil.

In one embodiment, the nut butter comprises from 35 to 65 wt. % nut derived solids. In one embodiment, the nut butter comprises from 40 to 60 wt. % nut derived solids. In one embodiment, the nut butter comprises from 45 to 55 wt. % nut derived solids.

In one embodiment, the nut butter comprises from 35 to 65 wt. % oil. In one embodiment, the nut butter comprises from 40 to 60 wt. % oil. In one embodiment, the nut butter comprises from 45 to 55 wt. % oil.

In one embodiment, the nut butter comprises from 35 to 65 wt. % nut derived solids and from 35 to 65 wt. % oil. In one embodiment, the nut butter comprises from 40 to 60 wt. % nut derived solids and from 40 to 60 wt. % oil. In one embodiment, the nut butter comprises from 45 to 55 wt. % nut derived solids and from 45 to 55 wt. % oil.

In one embodiment, the nut butter is selected from the group consisting of peanut butter, almond butter, cashew butter, hazelnut butter, macadamia nut butter, pecan putter, pistachio butter, soybean butter, sunflower butter, or walnut butter. In one embodiment, the nut butter is a mixture of one or more of peanut butter, almond butter, cashew butter, hazelnut butter, macadamia nut butter, pecan putter, pistachio butter, or walnut butter. In one embodiment, the nut butter is peanut butter.

In one embodiment, the nut derived solids and the nut derived oil are primarily both derived from the same nut source. In one embodiment, the nut derived solids and the nut derived oil are derived from different nut sources.

### Lactic Acid Esters of Mono- and Diglycerides

Lactic acid esters of mono- and diglycerides (LACTEM) may also be known as lactoglycerides, lactic acid and fatty acid esters of glycerol, mono- and diglycerides of fatty acids esterified with lactic acid, glycerol-lacto esters of fatty acids or lactated mono- and diglycerides.

The lactic acid esters of mono- and diglycerides of the present invention have the following structure:

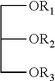

wherein at least one of R₁, R₂ or R₃ represents a lactic acid moiety, at least one of R₁, R₂ or R₃ represents a fatty acid moiety, with the remainder being any one of a lactic acid moiety, a fatty acid moiety or hydrogen, wherein the fatty acid moiety is independently selected from saturated, unsaturated or polyunsaturated fatty acids having a carbon chain length of from 6 to 26.

In one embodiment, at least one of R₁, R₂ or R₃ represents a lactic acid moiety and two of R₁, R₂ or R₃ represents a fatty acid moiety.

In one embodiment, the fatty acid moiety of the LACTEM is saturated. In one embodiment, the fatty acid moiety of the LACTEM is unsaturated. In one embodiment, the fatty acid moiety of the LACTEM is polyunsaturated.

In one embodiment, the fatty acid moiety has a carbon chain length of from 8 to 26. In one embodiment, the fatty acid moiety has a carbon chain length of from 10 to 26. In one embodiment, the fatty acid moiety has a carbon chain length of from 12 to 26. In one embodiment, the fatty acid moiety has a carbon chain length of from 14 to 26. In one embodiment, the fatty acid moiety has a carbon chain length of from 16 to 26. In one embodiment, the fatty acid moiety has a carbon chain length of from 18 to 26. In one embodiment, the fatty acid moiety has a carbon chain length of from 18 to 24.

In one embodiment, the LACTEM of the present invention is unsaturated and comprises at least one fatty acid chain having a carbon chain length of from 18 to 24. In one embodiment, the LACTEM of the present invention is saturated and comprises at least one fatty acid chain having a carbon chain length of from 18 to 24.

In one embodiment, the aerated nut butter comprises LACTEM in an amount of up to 1 wt. %. In one embodiment, the aerated nut butter comprises LACTEM in an amount of up to 0.9 wt. %. In one embodiment, the aerated nut butter comprises LACTEM in an amount of up to 0.8 wt. %. In one embodiment, the aerated nut butter comprises LACTEM in an amount of up to 0.75 wt. %. In one embodiment, the aerated nut butter comprises LACTEM in an amount of up to 0.7 wt. %. In one embodiment, the aerated nut butter comprises LACTEM in an amount of up to 0.6 wt. %. In one embodiment, the aerated nut butter comprises LACTEM in an amount of up to 0.5 wt. %. In one embodiment, the aerated nut butter comprises LACTEM in an amount of from 0.1 to 1 wt. %. In one embodiment, the aerated nut butter comprises LACTEM in an amount of from 0.2 to 0.9 wt. %. In one embodiment, the aerated nut butter comprises LACTEM in an amount of from 0.2 to 0.8 wt. %. In one embodiment, the aerated nut butter comprises LACTEM in an amount of from 0.4 to 0.6 wt. %. In one embodiment, the aerated nut butter comprises LACTEM in an amount of about 0.5 wt. %. In one embodiment, the aerated nut butter comprises LACTEM in an amount of about 0.25 wt. %.

In one embodiment, the nut butter comprises one or more other additives such as salt, sugar, emulsifiers, stabilizers, flavourants, fruit pieces, honey, chocolate, bulking agents, molasses, colourants, non-nut derived oil and other suitable additives.

In one embodiment, suitable emulsifiers may be one or more of mono-and diglycerides, distilled monoglycerides, citric acid esters of monoglycerides, di-acetyl acetic acid esters of monoglycerides, polyglycerol esters of fatty acids, propylene glycol monoesters, or sorbitan esters of fatty acids, any of which may be saturated or unsaturated.

In one embodiment, the aerated nut butter comprises at least one stabilizer. In this regard, the use of stabilizers in nut butters, and peanut butter in particular, is generally to prevent the separation of the oil from the solid content. Thus, the use of a “stabilizer” in the context of the present invention is to prevent such oil separation and is not intended to have any appreciable effect on air stabilization.

In one embodiment the at least one stabilizer is selected from saturated or unsaturated mono-diglycerides, fully hardened or partially hardened vegetable oil and polyglycerol esters of fatty acids. In one embodiment, the at least one stabilizer is a fully hardened or partially hardened vegetable oil. In one embodiment, the at least one stabilizer is a non-hydrogenated vegetable stabilizer, such as palm stearin. In one embodiment, the at least one stabilizer is a fully hardened vegetable oil. In one embodiment, the vegetable oil is selected from one or more of high erucic rapeseed, cotton seed and/or soybean oil. In one embodiment, the at least one stabilizer is a distilled monoglyceride made from fully hydrogenated oil. In one embodiment, the at least one stabilizer is a distilled monoglyceride made from partially hydrogenated oil. In one embodiment, the at least one stabilizer is a distilled monoglyceride made from unsaturated vegetable oil. In one embodiment, the stabilizer is a mixture of a distilled monoglyceride made from partially or fully hydrogenated oil and a fully hardened or partially hardened vegetable oil.

In one embodiment, when present, the at least one stabilizer should be present in the aerated nut butter in an amount of up to about 2 wt. %. In one embodiment, when present, the at least one stabilizer should be present in the aerated nut butter in an amount of up to 1.5 wt. %. In one embodiment, when present, the at least one stabilizer should be present in the aerated nut butter in an amount of up to 1.0 wt. %. In one embodiment, when present, the at least one stabilizer should be present in the aerated nut butter in an amount of from 0.5 to 2.0 wt. %. In one embodiment, when present, the at least one stabilizer should be present in the aerated nut butter in an amount of from 1.0 to 2.0 wt. %. In one embodiment, where there is more than one stabilizer present, the total amount of stabilizer in the composition should not exceed 2 wt. %.

In one embodiment, the aerated nut butter comprises LACTEM in an amount of up to 1 wt. % and a stabilizer in an amount of up to 2 wt. %. In one embodiment, the aerated nut butter comprises LACTEM in an amount of up to 1 wt. % and fully hardened or partially hardened vegetable oil in an amount of up to 2 wt. %.

In one embodiment, there is provided an aerated nut butter comprising from 35 to 65 wt. % nut derived solid particles, from 35 to 65 wt. % oil, preferably nut derived oil, up to 2 wt% of fully hardened or partially hardened vegetable oil, up to 1 wt. % of LACTEM and from 5 to 40% by volume of the final product incorporated air.

In a further aspect of the present invention, there is provided the use of lactic acid esters of mono- and diglycerides for improving the air stability of an aerated nut butter. In this aspect, the aerated nut butter and lactic acid esters of mono- and diglycerides are as defined above.

Therefore, in one embodiment of this aspect, there is provided use of lactic acid esters of mono- and diglycerides in an amount of up to 1 wt. % for improving the air stability of an aerated nut butter.

### Air Stability

In the context of the present invention, “air stability” refers to the stability of the air incorporated in an aerated nut butter in terms of air retention in the nut butter or air distribution in the nut butter.

Air retention can be assessed by measuring the rheology of the aerated nut butter. In particular, the storage modulus (G′) of a sample gives an indication of its elasticity, and therefore its firmness. A firmer sample generally corresponds to improved air retention in the sample. Air distribution can be assessed by comparing confocal laser scanning microscopy (CLSM) images of aerated nut butter samples.

In a further aspect of the present invention, there is provided a process for preparing an aerated nut butter comprising the steps of:

i) preparing a nut butter comprising nut derived solids, nut derived oil, and lactic acid esters of mono-and diglycerides;

ii) incorporating air in the nut butter to achieve an air incorporation of from 5 to 40% by volume of the aerated nut butter.

The aerated nut butter may have the characteristics of the aerated nut butter mentioned above and so those teachings refer equally to the process of the present invention.

The invention will now be described with reference to the following non-limiting examples.

### EXAMPLES

### Example 1—Peanut Butter Compositions

### Sample Preparation

1. The natural peanut butter was weighed out and heated to 80° C.;

2. The dextrose, salt, and other fat ingredients (as identified in the table below) were added to the natural peanut butter;

3. The peanut butter was then mixed until the ingredients were fully incorporated;

4. The peanut butter was then re-heated to 80° C.;

5. The peanut butter was then passed through a Monopump, Surface scrape heat exchange (SSHE) and Mondomixer under the following conditions:
Monopump: 40 kg/h; inlet temp. 70-80° C.
SSHE: output temp. 31-34° C.; rotorspeed 8.
Mondomixer: mixerhead 600 rpm; pressure 3.5 bar; density input 1.160; density out put 0.5; output temperature 26-30° C.

Samples 1 to 10 were prepared according to the above method. Samples 1 to 5 contained only a stabilizer (GRINSTED PS 105 K-A, DIMODAN HP or PS 208/B K-A). Samples 6 to 10 also contained an emulsifier (PGE 55-K, LACTEM P22—K, GRINDSTED PGMS USV K-A, or ACETEM 70-00 P-K).

TABLE 1

| SAMPLE NUMBER | 1 | 2 | 3 | 4 | 5 | 6 | 7 | 8 |
|---|---|---|---|---|---|---|---|---|
| Water phase* | | | | | | | | |
| Salt | 1.500 | 1.500 | 1.500 | 1.500 | 1.500 | 1.500 | 1.500 | 1.500 |
| DEXTROSE-K | 6.500 | 6.000 | 6.000 | 6.000 | 6.000 | 6.000 | 6.000 | 6.000 |
| Water phase total | 8.000 | 7.500 | 7.500 | 7.500 | 7.500 | 7.500 | 7.500 | 7.500 |
| Fat phase | | | | | | | | |
| Fat blend | | | | | | | | |
| Natural peanut butter | 90.500 | 90.500 | 90.500 | 90.500 | 90.500 | 90.500 | 90.500 | 90.500 |
| Fat blend total | 90.500 | 90.500 | 90.500 | 90.500 | 90.500 | 90.500 | 90.500 | 90.500 |
| Other fat ingredients | | | | | | | | |
| GRINDSTED ® PS 105 | | 2.000 | | 1.500 | 1.500 | 1.500 | | |
| K-A | | | | | | | | |
| DIMODAN HP | | | 2.000 | | | | | 1.500 |
| PS 208/B K-A | 1.500 | | | | | | 1.500 | |
| PGE 55-K | | | | 0.500 | | | | |
| LACTEM P 22- K | | | | | 0.500 | | 0.500 | 0.500 |
| GRINDSTED PGMS | | | | | | 0.500 | | |
| USV K-A | | | | | | | | |
| Other fat ingredients | 1.500 | 2.000 | 2.000 | 2.000 | 2.000 | 2.000 | 2.000 | 2.000 |
| total | | | | | | | | |
| Fat phase total | 92.000 | 92.500 | 92.500 | 92.500 | 92.500 | 92.500 | 92.500 | 92.500 |
| Air Incorporation % un- | 31.97 | 31.47 | 29.46 | 29.58 | 30.84 | 25.82 | 32.49 | — |
| aerated product | | | | | | | | |
| RECIPE total % (calc. | 100.00 | 100.00 | 100.00 | 100.00 | 100.00 | 100.00 | 100.00 | 100.00 |
| batch size) | | | | | | | | |

Grindsted ® PS 105 K-A is a kosher approved blend of edible, refined, fully hydrogenated rapeseed, cottonseed and soybean oils available from DuPont Nutrition Biosciences Aps.
Dimodan HP is a distilled monoglyceride available from DuPont Nutrition Biosciences Aps.
PS 208/B K-A is a kosher approved edible fully hydrogenated vegetable oil available from DuPont Nutrition Biosciences Aps.
PGE 55-K is a polyglycol ester available from DuPont Nutrition Biosciences Aps.
Lactem P 22-K is a kosher approved edible lactic acid ester of mono-and diglycerides available from DuPont Nutrition Biosciences Aps.
Grindsted ® PGMS USV K-A is a kosher approved edible propylene glycol monostearate available from DuPont Nutrition Biosciences Aps.
Acetem 70-00 P-K is a kosher approved edible acetylated mono-diglyceride available from DuPont Nutrition Biosciences Aps.
*Reference to a “water phase” is only relative to the presence of the “fat phase” and no water is actually present, as is clear from the components of the “water phase”.

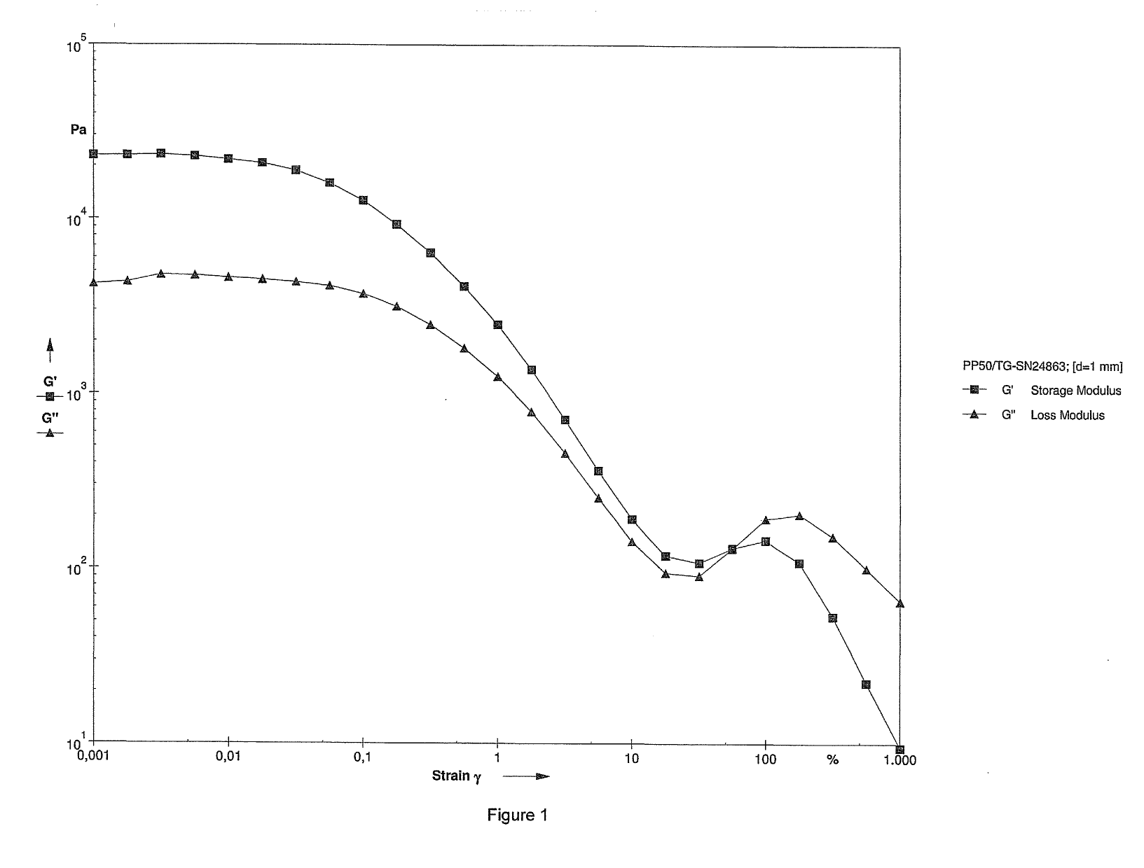

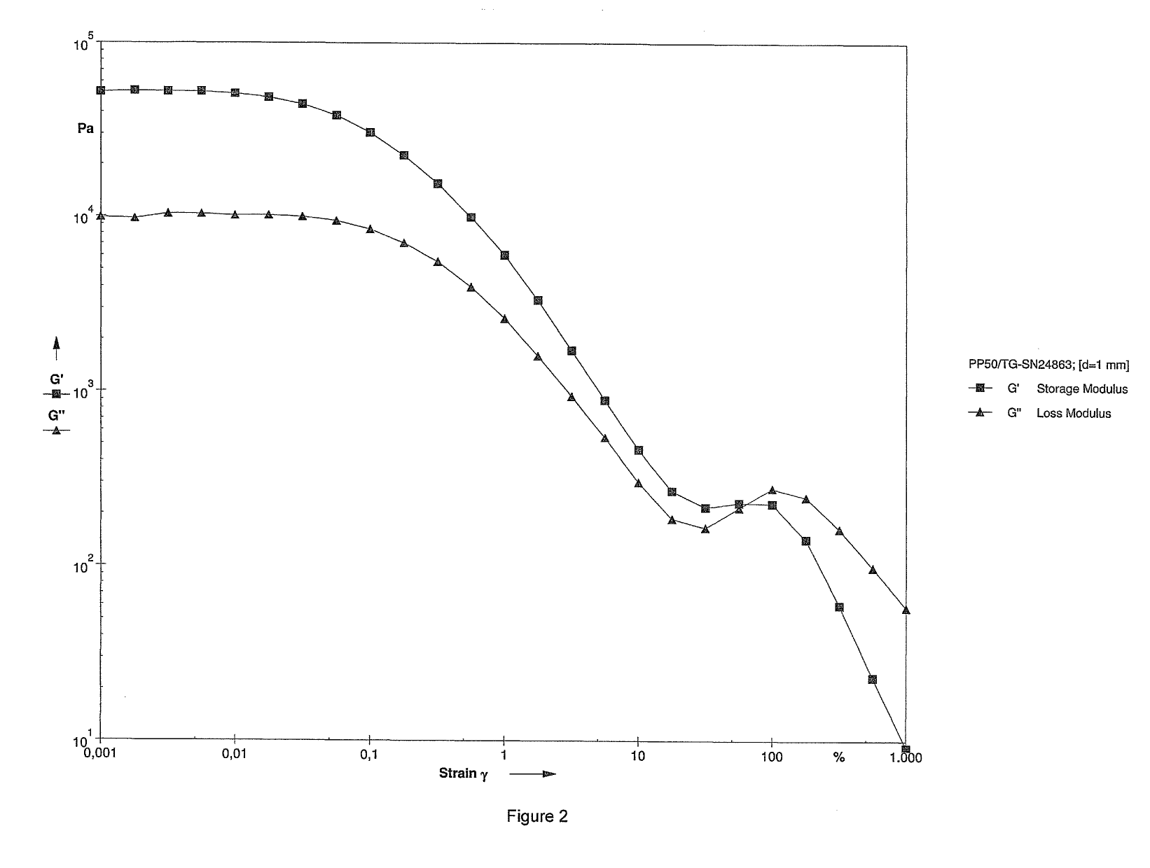

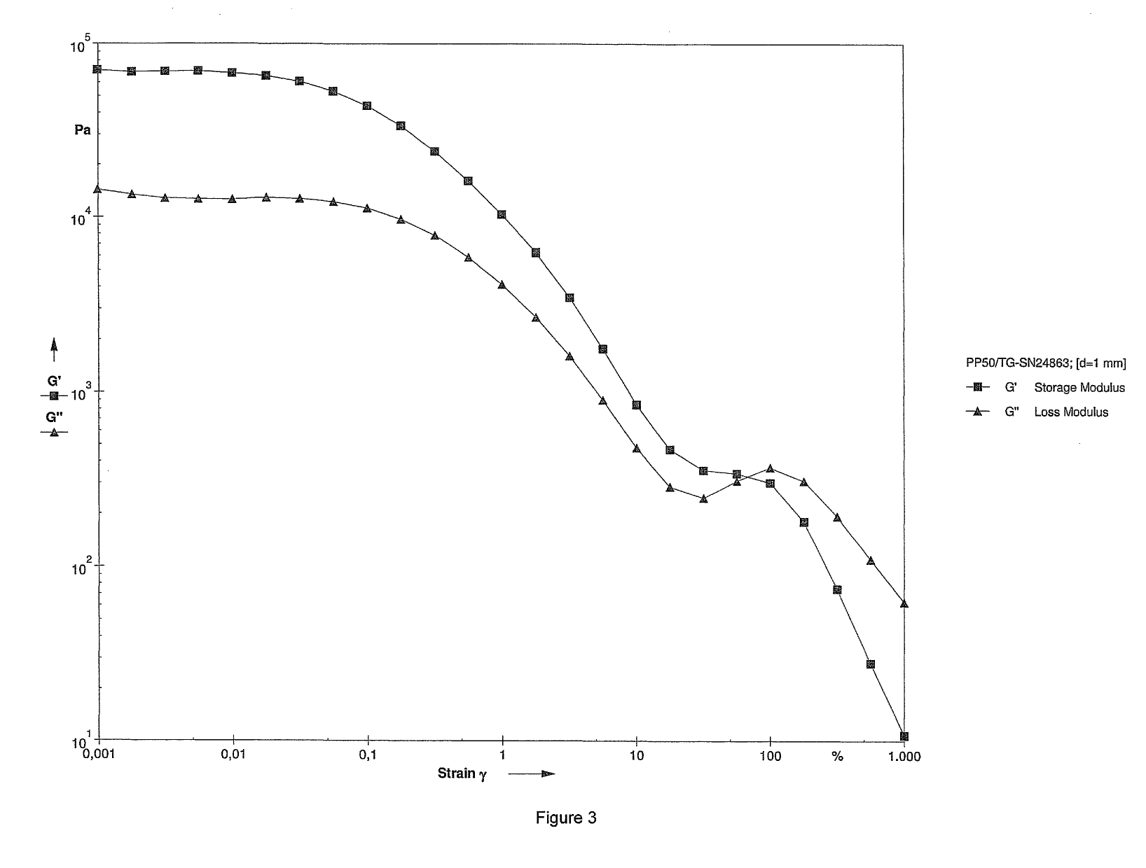

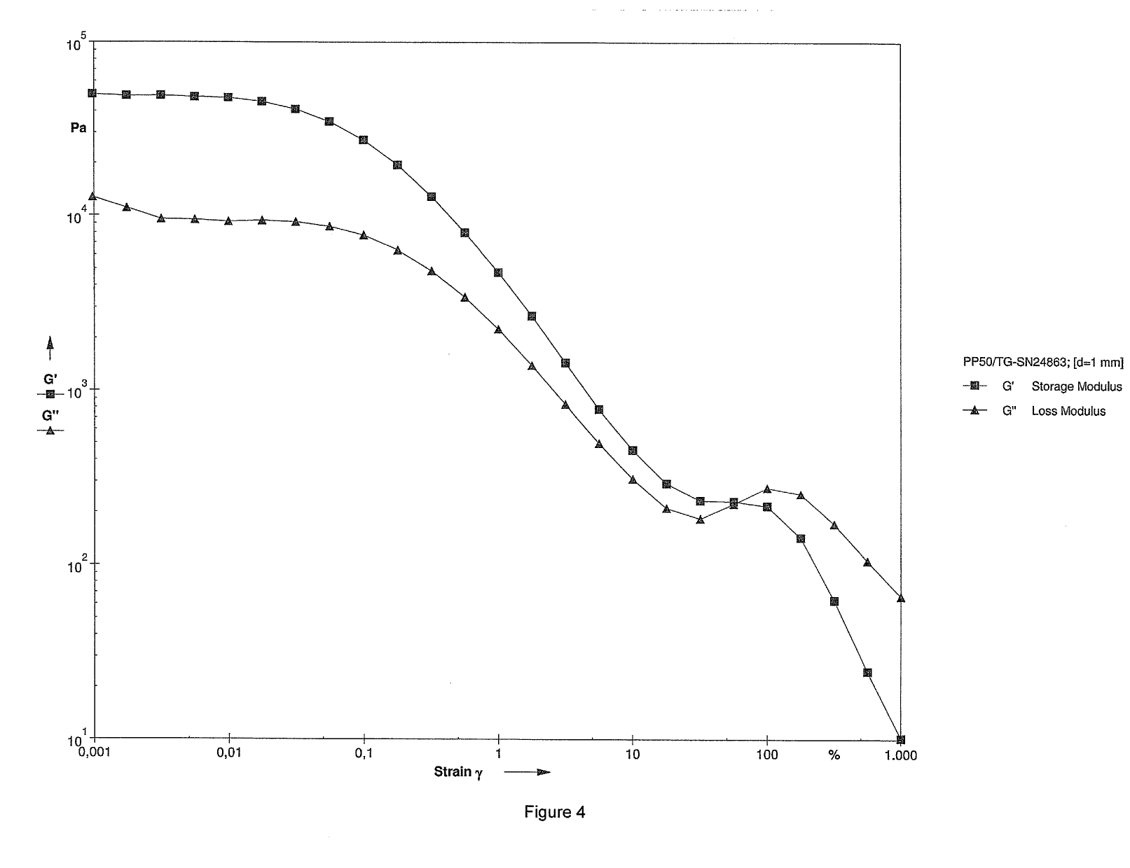

The rheology profile of each sample was analyzed. In particular, the storage (G′) and loss (G″) modulus of the samples were measured using a rheometer (Physica MCR 301 from Anton Pear; plate system with 1 mm gap at 20° C.). The storage modulus (G′) gives an indication of the elasticity, and thus the firmness, of the sample. A greater value for a indicates that the sample was firmer and corresponds to improved air stability in the sample. The results are shown in FIGS. 1 to 4. Sample 4 which only contained a stabilizer had the worst G′ value of the samples tested (FIG. 1). By contrast, samples 5 (FIG. 2), 7 (FIG. 3) and 8 (FIG. 4) which contained lactic acid esters of mono-and diglycerides had a significantly improved G′, indicating an improvement in the air stability of the peanut butter.

The results show that the use of lactic acid esters of mono-and diglycerides in an aerated peanut butter is capable of improving the stability of the incorporated air.

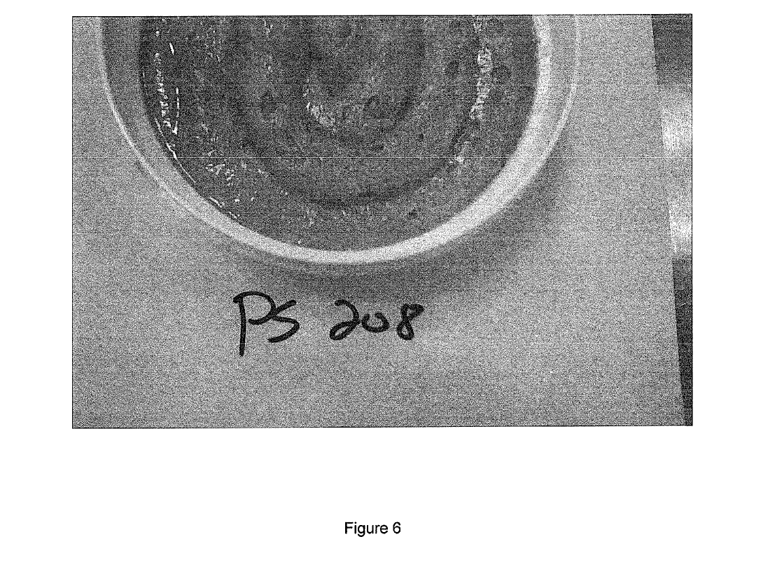

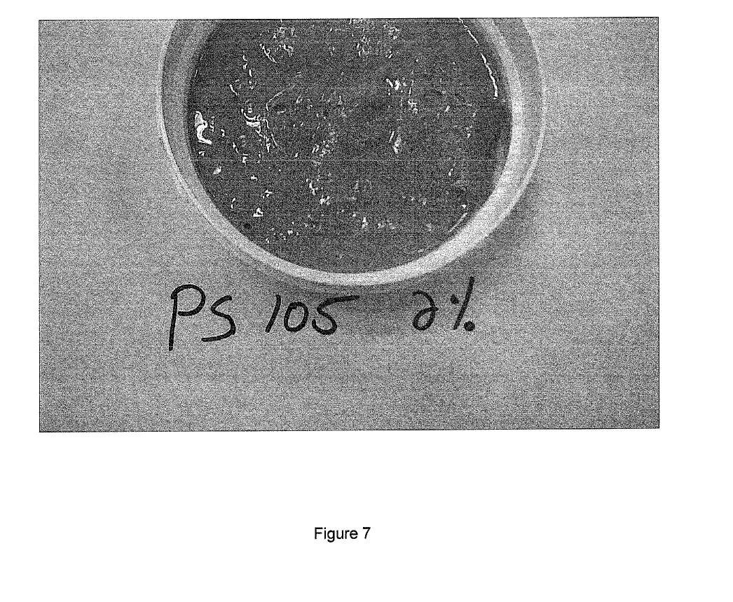

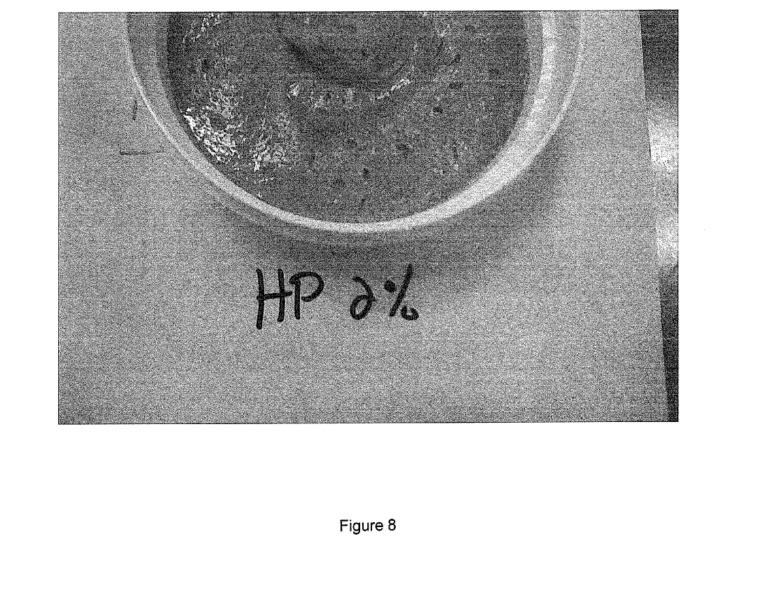

The ability of lactic acid esters of mono-and diglycerides to also improve the air stability in the peanut butter as a result of providing a more even air distribution can be seen in FIGS. 6 to 12.

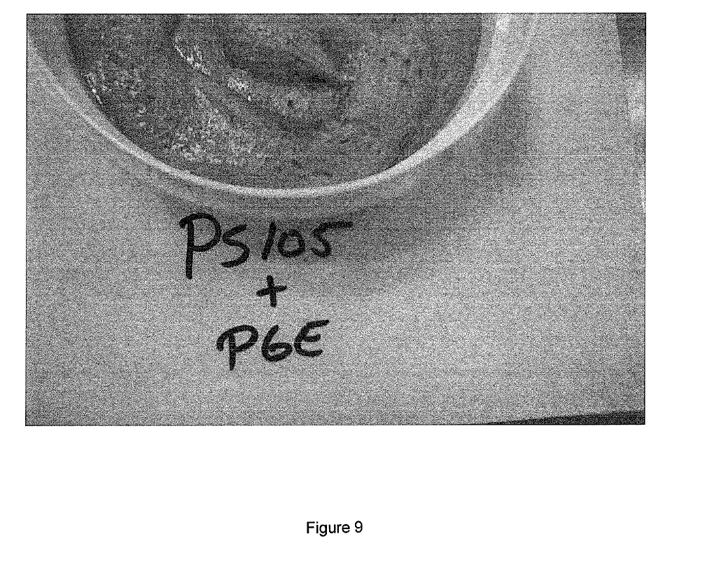

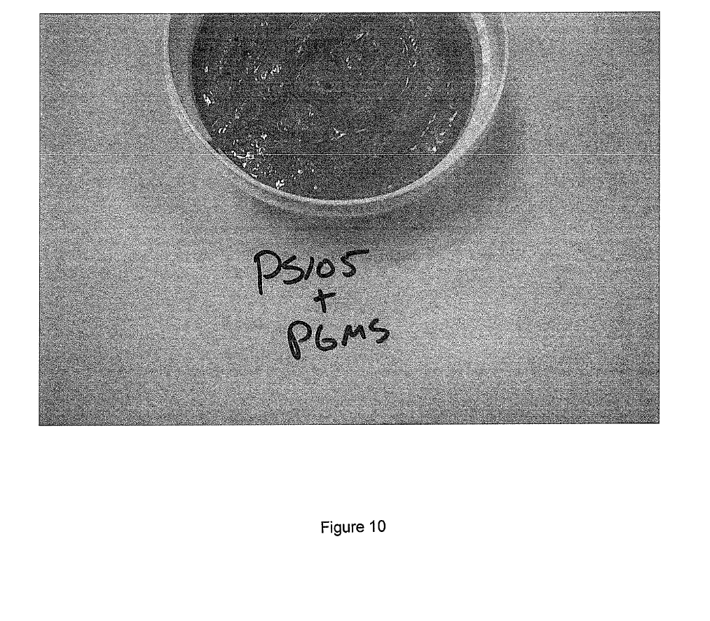

In particular, samples 1, 2 and 3 (FIGS. 6, 7 and 8 respectively) all show peanut butters containing large air pockets, illustrated by the burst air pockets on the surface of the peanut butter. Such an air distribution is unsatisfactory as it results in a peanut butter which has a poor visual appearance. The addition of PGMS and PGE in samples 4 and 6 (FIGS. 9 and 10 respectively) did not overcome this problem (the burst air pockets still remain).

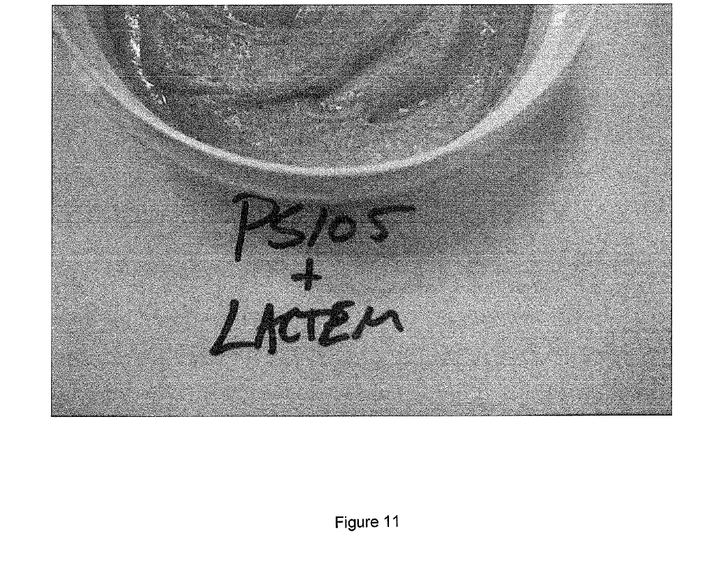

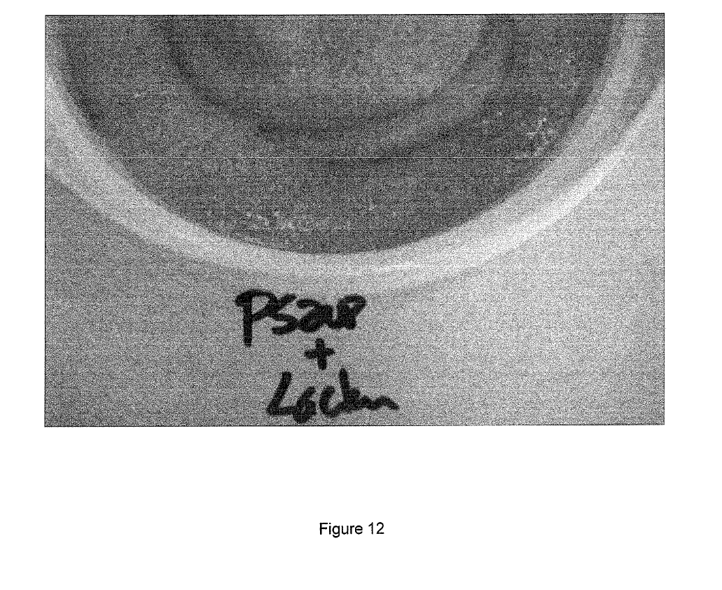

In contrast, FIG. 11 is a peanut butter sample that also comprises lactic acid esters of mono-and diglycerides. The aerated peanut butter contains air evenly distributed throughout the sample and is not characterized by the large burst air pockets seen in the other samples. The even air distribution that results from the use of lactic acid esters of mono-and diglycerides is confirmed in sample 7 (FIG. 12), which again is not characterized by large burst air pockets.

### Example 2—Peanut Butter Compositions Comprising Lactic Acid Esters of Mono-and Diglycerides in Varying Amounts

Further work was done to establish the effect of lactic acid esters of mono-and diglycerides at different wt. % of the sample. Samples 9 and 10 were prepared in a similar manner to samples 1 to 8 mentioned above.

TABLE 2

| SAMPLE NUMBER | 9 | 10 |
|---|---|---|
| Water phase | | |
| DEXTROSE-K | 6,250 | 6,400 |
| Salt | 1,500 | 1,500 |
| Water phase total | 7,750 | 7,900 |
| Fat phase | | |
| Fat blend | | |
| Natural peanut butter | 90,500 | 90,500 |
| Fat blend total | 90,500 | 90,500 |
| Other fat ingredients | | |
| PS 208/B K-A | 1,500 | 1,500 |
| LACTEM P22-K | 0,250 | 0,100 |
| Other fat ingredients total | 1,750 | 1,600 |
| Fat phase total | 92,250 | 92,100 |
| Air Incorporation % un-aerated product | 30.79 | 27.11 |
| RECIPE total % (calc. batch size) | 100,000 | 100,000 |

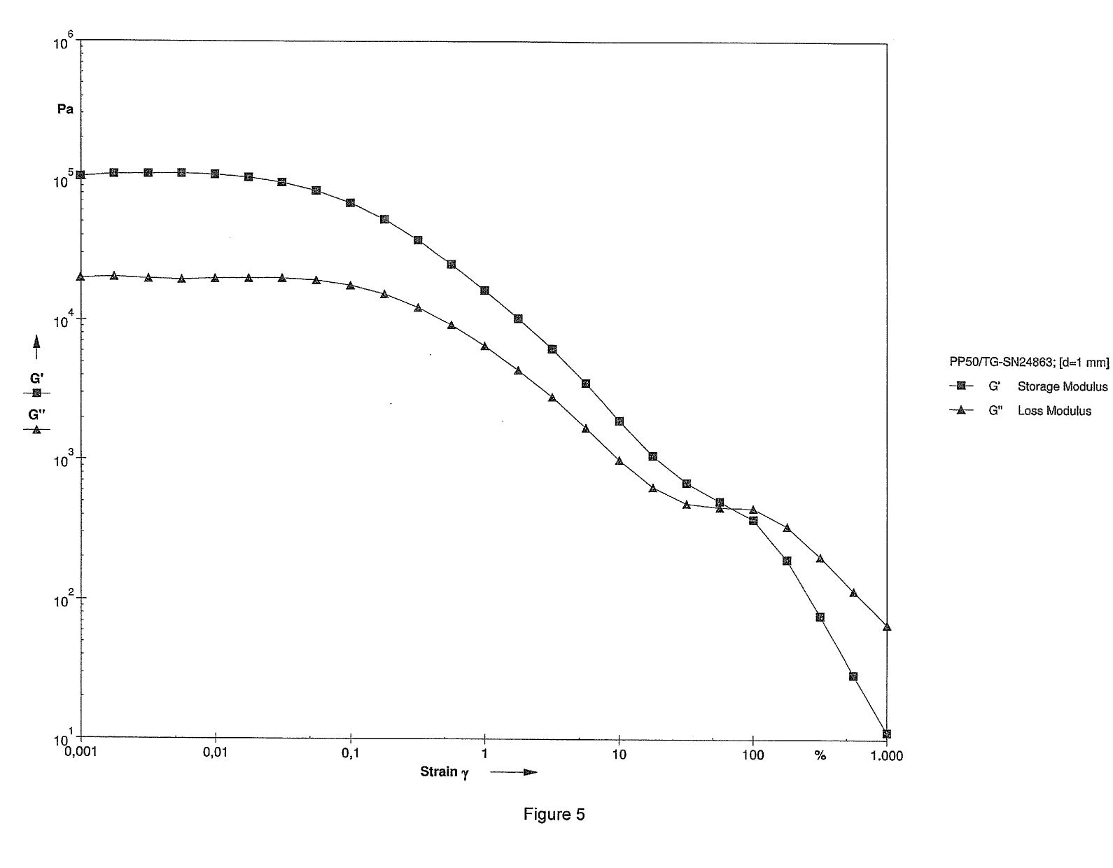

The results show that lactic acid esters of mono-and diglycerides at a range of concentrations are able to improve the stability of the air incorporated into peanut butter. In particular, using 0.25 wt. % of lactic acid esters of mono-and diglycerides as in sample 9 showed a significant increase in a G′ (FIG. 5).

All publications mentioned in the above specification are herein incorporated by reference. Various modifications and variations of the described invention will be apparent to those skilled in the art without departing from the scope and spirit of the invention. Although the invention has been described in connection with specific preferred embodiments, it should be understood that the invention as claimed should not be unduly limited to such specific embodiments.

1. An aerated nut butter comprising lactic acid esters of mono- and diglycerides.

2. The aerated nut butter of claim 1, comprising lactic acid esters of mono-and diglycerides in an amount of up to 1 wt. %.

3. The aerated nut butter of claim 1, comprising lactic acid esters of mono-and diglycerides in an amount of from 0.1 to 1 wt. %.

4. The aerated nut butter of claim 1, wherein the aerated nut butter comprises 35 to 65 wt. % nut derived solids.

5. The aerated nut butter of claim 1, wherein the aerated nut butter comprises 35 to 65 wt. % nut derived oil.

6. The aerated nut butter of claim 1, wherein the aerated nut butter comprises at least one stabilizer in an amount of up to 2 wt. %.

7. The aerated nut butter of claim 6, wherein the at least one stabilizer is a partially or fully hydrogenated vegetable oil.

8. The aerated nut butter of claim 1, wherein the aerated nut butter comprises at least 5% by volume incorporated air.

9. The aerated nut butter of claim 8, wherein the aerated nut butter comprises from 5 to 50% by volume incorporated air.

10. The aerated nut butter of claim 1, wherein the aerated nut butter is peanut butter.

11. The aerated nut butter of claim 10, wherein the nut butter is peanut butter comprising from 35 to 65 wt. % peanut derived solids, from 35 to 65 wt. % peanut derived oil, up to 2 wt % of fully hardened or partially hardened vegetable oil, up to 1 wt. % of lactic acid esters of mono-and diglycerides and from 5 to 50% by volume incorporated air.

12. A process for improving the air stability of an aerated nut butter, wherein the process comprises:
i) preparing a nut butter comprising nut derived solids, nut derived oil and lactic acid esters of mono-and diglycerides; and
ii) incorporating air into the nut butter.

13. The process according to claim 12, wherein the aerated nut butter is as defined in claim 11.

14. A process for preparing an aerated nut butter comprising the steps of:
i) preparing a nut butter comprising nut derived solids, nut derived oil, and lactic acid esters of mono-and diglycerides; and
ii) incorporating air in the nut butter to achieve an air incorporation of from 5 to 40% by volume of the aerated nut butter.

15. A process according to claim 14, wherein at least one stabilizer is added in step i).

16. A process according to claim 15, wherein the at least one stabilizer is a partially or fully hydrogenated vegetable oil.

17. A process according to claim 14, wherein one or more additional additives are added in step i).

18. The process according to claim 14, wherein the nut butter comprises from 35 to 65 wt. % nut derived solids, from 35 to 65 wt. % nut derived oil, up to 2 wt. % of fully hardened or partially hardened vegetable oil and up to 1 wt. % of lactic acid esters of mono-and diglycerides.

19. The process according to claim 14, wherein the nut butter is peanut butter.

20-22. (canceled)
